(19) United States
(12) Patent Application Publication
(10) Pub. No.: US 2016/0197376 A1
(43) Pub. Date: Jul. 7, 2016

(54) NON-AQUEOUS ELECTROLYTE SECONDARY BATTERY AND METHOD FOR MANUFACTURING THE SAME

(71) Applicant: ISHIHARA SANGYO KAISHA, LTD., Osaka (JP)

(72) Inventors: Nobuharu Koshiba, Mie (JP); Yoshimasa Kumashiro, Mie (JP); Kazuhiro Akagawa, Mie (JP)

(21) Appl. No.: 14/912,839

(22) PCT Filed: May 21, 2014
(86) PCT No.: PCT/JP2014/063484

§ 371 Date: Feb. 18, 2016

(30) Foreign Application Priority Data
Sep. 5, 2013 (JP) 2013-183741

(51) Int. Cl. H01M 10/0567; H01M 10/44; H01M 10/058; H01M 4/485; H01M 10/0525

(52) U.S. Cl. CPC H01M 10/0567; H01M 4/485; H01M 10/0525; H01M 10/058; H01M 10/446; H01M 2004/027

(57) ABSTRACT

A non-aqueous electrolyte secondary battery includes: a positive electrode; a negative electrode that includes an active material containing a titanium oxide having a lithium ion storage potential of 1.2 V or higher (versus Li/Li⁺); and a non-aqueous electrolyte solution that contains a lithium salt and a non-aqueous solvent that dissolves the lithium salt therein. The non-aqueous electrolyte solution contains a dinitrile compound and/or a reaction product of the dinitrile compound.

### TECHNICAL FIELD

The present invention relates to non-aqueous electrolyte secondary batteries and methods for manufacturing the same. More particularly, the present invention relates to a non-aqueous electrolyte secondary battery using a titanium oxide as a negative electrode active material, which reduces generation of gas associated with the use of the battery under high temperature environment and reduces capacity deterioration of the battery, and a method for manufacturing the same.

### BACKGROUND ART

Non-aqueous electrolyte batteries that are charged and discharged by movement of lithium ions between negative and positive electrodes have been actively researched and developed as batteries with high energy density. Non-aqueous electrolyte batteries using a lithium-transition metal composite oxide as a positive electrode active material and using a carbon material as a negative electrode active material are currently available on the market.

In recent years, titanium oxides having a higher lithium ion storage/release potential than carbon materials have attracted attention as negative electrode active materials (e.g., Patent Literatures 1 to 3). In titanium oxides having a lithium ion storage potential of 1.2 V or higher (versus Li/Li⁺), a metal lithium is essentially less likely to be deposited due to a significant difference between the lithium ion storage potential and a metal lithium deposition potential even if the battery is rapidly charged or is charged at a low temperature. For example, Li₄Ti₅O₁₂ is structurally degraded very slowly because its unit crystal lattice hardly changes with charge and discharge of the battery. Accordingly, batteries using a titanium oxide as a negative electrode active material are very safe and are expected to have excellent battery properties, especially excellent cycle life properties.

However, since such titanium oxides have a lithium ion storage/release potential as high as 1.2 V or higher (versus Li/Li⁺), a stable protective coating film called an SEI coating film is less likely to be formed on the surface, unlike the case of using a carbon active material. Accordingly, there are problems that a non-aqueous electrolyte solution is continuously reductively decomposed to generate gas. In particular, when the batteries are charged and discharged under high temperature environment, there are problems that gas tends to be generated and battery capacity is deteriorated. Generation of a large amount of gas may cause an increase in internal pressure or swelling of the batteries. Generation of a large amount of gas also accelerates capacity deterioration of the batteries and reduces life properties.

Various solutions using conditioning of the batteries have been proposed to these problems. For example, Patent Literature 2 discloses a method for manufacturing a non-aqueous electrolyte battery comprising a negative electrode having a negative electrode active material in which lithium ions are inserted and desorbed at a potential equal to or higher than 1.2 V versus a lithium potential. This method is characterized in that a negative electrode potential is reduced to 0.8 V or less versus the lithium potential in an initial cycle so that a coating film having a carbonate structure is present on the surface of the negative electrode. Patent Literature 2 describes that this method reduces generation of gas in the non-aqueous electrolyte battery. This method is effective in reducing generation of gas when the battery is manufactured or when the battery is left at room temperature. However, it has been found that the initial battery capacity is significantly reduced by the above process, and generation of gas is not sufficiently reduced if the battery is repeatedly charged and discharged under high temperature environment.

Patent Literature 3 discloses a method for manufacturing a non-aqueous electrolyte secondary battery comprising a lithium titanium oxide in a negative electrode. The method includes adjusting the state of charge (SOC) of a temporarily sealed secondary battery to less than 20% (not including 0%), retaining the adjusted temporarily sealed secondary battery in an atmosphere of 50° C. to 90° C., and opening the temporarily sealed secondary battery to discharge gas therefrom. Patent Literature 3 describes that this method reduces generation of gas during storage of the battery at a high temperature and reduces an increase in resistance. This method is effective in reducing generation of gas when the battery is stored under high temperature environment with SOC as low as 50% or less. However, it has been found that generation of gas is not sufficiently reduced when the battery is repeatedly charged and discharged under high temperature environment.

With the expanding applications of secondary batteries in recent years, there is a growing demand for batteries with higher energy density. In response to the demand, efforts have been made to arrange more densely electrodes in the batteries and to reduce space in the batteries. The demand for reduction in generation of gas is therefore becoming more significant.

In recent years, there have been growing expectations for applications of medium- or large-sized non-aqueous electrolyte batteries as power supplies for power storage systems or as in-vehicle power supplies for HEVs etc. Such applications require active materials having excellent rapid charge and discharge properties. For example, the power supplies for power storage systems using such an active material efficiently store electricity even if they receive a large current from natural energy that varies significantly. The in-vehicle power supplies using such an active material efficiently collect a large current that is generated by a regenerative brake etc.

Patent Literatures 4 to 9 propose techniques of reducing oxidative decomposition of a non-aqueous electrolyte solution on a positive electrode by adding a nitrile compound or a compound having a carbon-nitrogen unsaturated bond to the electrolyte solution. These Patent Literatures examine the case of using a carbon negative electrode including a negative electrode active material having a lithium storage/release potential of about 0.1 V (versus Li/Li⁺), and does not specifically consider the case of using a negative electrode active material having a relatively high lithium ion storage/release potential.

### CITATION LIST

### Patent Literatures

Patent literature 1: JP 3502118B
Patent literature 2: WO2007/064046
Patent literature 3 JP 2012-79561A
Patent literature 4 JP 2010-15968A
Patent literature 5 JP 2012-18801A
Patent literature 6 JP 2010-56076A
Patent literature 7 JP 2010-71083A
Patent literature 8 JP 2011-198530A
Patent literature 9 JP 2012-134137A

### SUMMARY OF INVENTION

### Technical Problem

It is an object of the present invention to provide a non-aqueous electrolyte secondary battery using a titanium oxide as a negative electrode active material, which reduces generation of gas associated with the use of the battery under high temperature environment, in particular, associated with repeated charge and discharge under high temperature environment (high temperature cycling), and reduces capacity deterioration of the battery, and which have excellent rapid charge and discharge properties.

### Solution to Problem

The inventors intensively studied solutions to the above problems. As a result, the inventors found that the above problems are solved by a non-aqueous electrolyte battery comprising a negative electrode that includes an active material containing a titanium oxide having a lithium ion storage potential of 1.2 V or higher (versus Li/Li⁺), and a non-aqueous electrolyte solution containing a dinitrile compound and/or a reaction product of the dinitrile compound. The inventors thus arrived at the present invention.

(1) That is, according to the present invention, a non-aqueous electrolyte secondary battery comprises: a positive electrode; a negative electrode that includes an active material containing a titanium oxide having a lithium ion storage potential of 1.2 V or higher (versus Li/Li⁺); and a non-aqueous electrolyte solution that contains a lithium salt, a non-aqueous solvent, and a dinitrile compound and/or a reaction product of the dinitrile compound.

A coating film forming agent such as vinylene carbonate is used in conventional non-aqueous electrolyte batteries comprising a carbon material as a negative electrode active material. As the carbon material has a lithium storage/release potential as low as about 0.1 V (versus Li/Li⁺), this coating film forming agent forms a stable coating film called “SEI” on the surface of a negative electrode, thereby reducing reductive decomposition of a non-aqueous electrolyte solution at the surface of the negative electrode. Accordingly, in non-aqueous electrolyte batteries using a titanium oxide having a high lithium ion storage/release potential as a negative electrode active material, an SEI coating film is not formed, and it is difficult to use such non-aqueous electrolyte batteries under high temperature environment. According to the configuration of the present invention, a non-aqueous electrolyte secondary battery is provided which reduces generation of gas due to continuous reductive decomposition of a non-aqueous electrolyte solution associated with a high temperature cycling and reduces capacity deterioration of the battery and which has excellent rapid charge and discharge properties.

Although the mechanism of how the configuration of the present invention reduces generation of gas associated with a high temperature cycling and reduces capacity deterioration of the battery is not clear, the effect of cyano groups of the dinitrile compound and/or the reaction product thereof, in particular, the presence of two cyano groups, and the use of an oxide as a negative electrode active material should contribute to the mechanism. The dinitrile compound and/or the reaction product thereof should therefore act not only on the positive electrode but also on the titanium oxide in the negative electrode to prevent direct contact between the titanium oxide and the electrolyte solution components and to inhibit electron transfer from the titanium oxide to the electrolyte solution components, thereby reducing decomposition of the electrolyte solution component and reducing generation of gas and excessive formation of a coating film. This inference does not limit the present invention.

(2) In the non-aqueous electrolyte secondary battery according to (1), a total amount of the dinitrile compound and/or the reaction product of the dinitrile compound in the non-aqueous electrolyte solution is 1 to 5 mass %. This content range allows reduction in generation of gas associated with a high temperature cycling and reduction in capacity deterioration of the battery as well as excellent rapid charge and discharge properties to be achieved at a high level.

(3) In the non-aqueous electrolyte secondary battery according to (1) or (2), charge capacity of the non-aqueous electrolyte secondary battery is regulated by the negative electrode. With the configuration in which the charge capacity is regulated by the negative electrode, a non-aqueous electrolyte secondary battery is provided which reduces degradation of not only the non-aqueous electrolyte solution but also a positive electrode active material itself, which further reduces generation of gas associated with a high temperature cycling and further reduces capacity deterioration of the battery, and which has further improved rapid charge and discharge properties.

(4) In the non-aqueous electrolyte secondary battery according to any one of (1) to (3), the lithium salt includes at least lithium hexafluorophosphate and lithium tetrafluoroborate. This configuration further reduces capacity deterioration of the battery associated with a high temperature cycling and further improves the rapid charge and discharge properties.

(5) In the non-aqueous electrolyte secondary battery according to (4), concentration of the lithium tetrafluoroborate in the non-aqueous electrolyte solution is 0.001 to 0.5 mol/l. This content range further reduces capacity deterioration of the battery associated with a high temperature cycling.

(6) In the non-aqueous electrolyte secondary battery according to any one of (1) to (5), the non-aqueous electrolyte solution contains the dinitrile compound before initial charge. For example, the inventions of (1) to (5) are obtained as described in the invention of (6).

(7) In the non-aqueous electrolyte secondary battery according to any one of (1) to (6), the dinitrile compound is at least one selected from malononitrile, succinonitrile, glutaronitrile, and adiponitrile. The use of at least one selected from these materials as the dinitrile compound is more effective in solving the above problem.

(8) In the non-aqueous electrolyte secondary battery according to any one of (1) to (7), the titanium oxide is selected from lithium titanate with a spinel structure, lithium titanate with a ramsdellite structure, a monoclinic titanic acid compound, a monoclinic titanium oxide, and lithium hydrogen titanate. By using these materials as the titanium oxide having a lithium ion storage potential of 1.2 V or higher (versus Li/Li⁺) according to the present invention, a non-aqueous electrolyte secondary battery is provided which reduces generation of gas associated with a high temperature cycling and reduces capacity deterioration of the battery and which has excellent rapid charge and discharge properties.

(9) In the non-aqueous electrolyte secondary battery according to any one of (1) to (8), the titanium oxide is selected from Li₄₊ₓTi₅O₁₂, Li₂₊ₓTi₃O₇, a titanic acid compound given by a general formula H₂TiₙO₂ₙ₊₁, and a bronze titanium oxide. Specifically, these substances are preferably used as the titanium oxide having a lithium ion storage potential of 1.2 V or higher (versus Li/Li⁺) according to the present invention.

(10) In the non-aqueous electrolyte secondary battery according to any one of (1) to (9), the titanium oxide has a specific surface area of 5 m²/g or more as measured by a single-point BET method using nitrogen adsorption. In the case of using a negative electrode active material containing such a titanium oxide having a large surface area, a large amount of gas is usually generated under high temperature environment. However, even if the present invention is applied to a titanium oxide having a large surface area, generation of gas is sufficiently reduced and in particular, generation of gas associated with a high temperature cycling is significantly reduced. Moreover, a non-aqueous electrolyte secondary battery having excellent rapid charge and discharge properties and excellent large current discharge properties is obtained.

(11) In the non-aqueous electrolyte secondary battery according to any one of (1) to (10), the non-aqueous electrolyte solution contains at least one selected from ethylene carbonate, vinylene carbonate, ethylene sulfite, and 1,3-propanesultone. The use of such an additive further reduces generation of gas associated with a high temperature cycling.

(12) In the non-aqueous electrolyte secondary battery according to any one of (1) to (11), an active material of the positive electrode is lithium iron phosphate. In the present invention, lithium iron phosphate is preferably used as a positive electrode active material.

(13) In the non-aqueous electrolyte secondary battery according to any one of (1) to (11), an active material of the positive electrode is a lithium manganese composite oxide with a spinel structure. In the present invention, the lithium manganese composite oxide with a spinel structure is preferably used as the positive electrode active material.

(14) According to the present invention, a method for manufacturing a non-aqueous electrolyte secondary battery comprising: a positive electrode; a negative electrode that includes an active material containing a titanium oxide having a lithium ion storage potential of 1.2 V or higher (versus Li/Li⁺); and a non-aqueous electrolyte solution that contains at least a lithium salt, a non-aqueous solvent, and a dinitrile compound comprises the steps of sealing an opening of a packaging member containing the positive electrode, the negative electrode, and the non-aqueous electrolyte solution to produce a sealed secondary battery; and charging the sealed secondary battery. The non-aqueous electrolyte secondary battery according to (1) is produced in this manner.

(15) According to the present invention, a method for manufacturing a non-aqueous electrolyte secondary battery comprising: a positive electrode; a negative electrode that includes an active material containing a titanium oxide having a lithium ion storage potential of 1.2 V or higher (versus Li/Li⁺); and a non-aqueous electrolyte solution that contains at least a lithium salt, a non-aqueous solvent that dissolves the lithium salt therein, and a dinitrile compound comprises the steps of temporarily sealing an opening of a packaging member containing the positive electrode, the negative electrode, and the non-aqueous electrolyte solution to produce a temporarily sealed secondary battery; adjusting a negative electrode potential of the temporarily sealed secondary battery to a potential higher than 0.8 V and equal to or lower than 1.4 V (versus Li/Li⁺) and storing the temporarily sealed secondary battery in an atmosphere of 50° C. or higher and lower than 80° C.; and opening the temporarily sealed secondary battery to discharge gas therefrom, and then finally sealing the packaging member. Generation of gas associated with a high temperature cycling is reduced by adopting such conditioning in the method for manufacturing a battery comprising a negative electrode that includes an active material containing a titanium oxide, and a non-aqueous electrolyte solution that contains a dinitrile compound.

(16) In the method according to (15), the storage of the temporarily sealed secondary battery is performed in an open circuit. In particular, performing the conditioning in this state reduces capacity deterioration of the battery associated with the conditioning.

### Advantageous Effects of Invention

According to the present invention, a non-aqueous electrolyte secondary battery is provided which reduces generation of gas associated with a high temperature cycling and reduces capacity deterioration of the battery and which has excellent rapid charge and discharge properties.

### BRIEF DESCRIPTION OF DRAWINGS

FIG. 1 is a plan view showing a non-aqueous electrolyte secondary battery according to an embodiment of the present invention.

FIG. 2 is a sectional view showing the non-aqueous electrolyte secondary battery according to the embodiment of the present invention.

### DESCRIPTION OF EMBODIMENTS

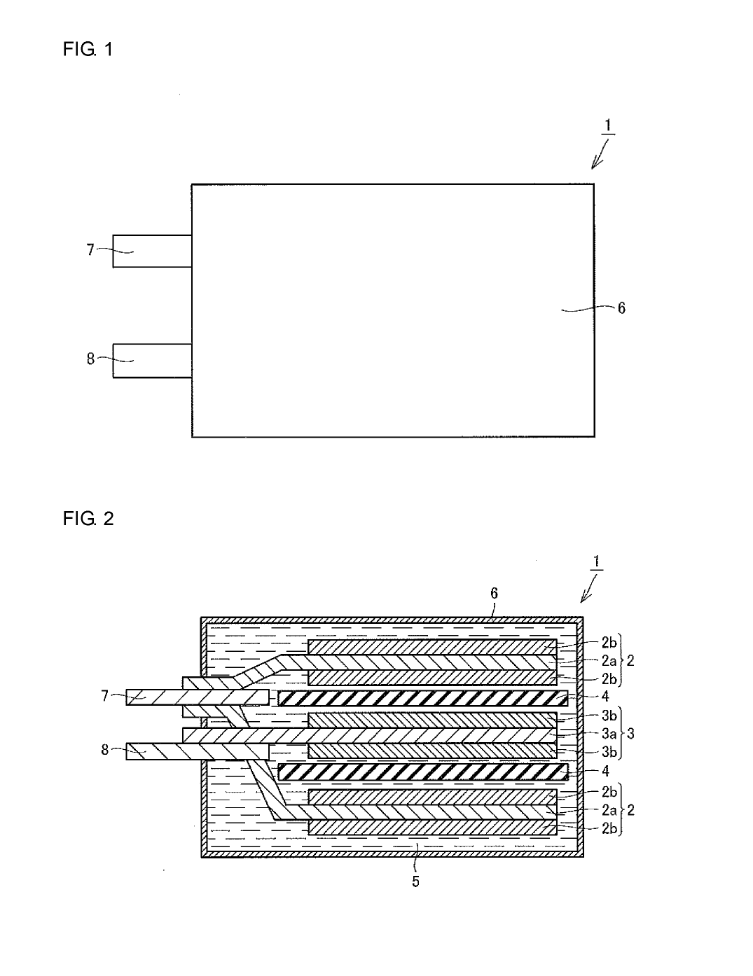

As shown in FIGS. 1 and 2, a non-aqueous electrolyte secondary battery 1 of the present invention comprises a positive electrode 2, a negative electrode 3 that includes an active material containing a titanium oxide having a lithium ion storage potential of 1.2 V or higher (versus Li/Li⁺), and a non-aqueous electrolyte solution 5 containing a lithium salt, a non-aqueous solvent, and a dinitrile compound and/or a reaction product of the dinitrile compound. The non-aqueous electrolyte secondary battery 1 also has a separator 4 that separates the positive and negative electrodes from each other, and a packaging member 6 that accommodates these members.

The negative electrode 3 includes at least a negative electrode current collector 3a and a negative electrode active material layer 3b. The negative electrode active material layer is formed on one or both surfaces of the negative electrode current collector. The negative electrode active material layer contains at least a negative electrode active material and may contain a conductive material, a binder, or other material as necessary. For example, aluminum or an aluminum alloy, or copper or a copper alloy is used for the negative electrode current collector.

A titanium oxide having a lithium ion storage potential of 1.2 V or higher (versus Li/Li⁺) is used as the negative electrode active material. Examples of such an active material include lithium titanate with a spinel structure (Li₄₊ₓTi₅O₁₂ (where x is a real number that satisfies 0≦x≦3), storage potential: 1.55 V versus Li/Li⁺), lithium titanate with a ramsdellite structure (Li₂₊ₓTi₃O₇ (where x is a real number that satisfies 0≦x≦3), storage potential: 1.6 V versus Li/Li⁺), a monoclinic titanium oxide, and lithium hydrogen titanate. Examples of the monoclinic titanium oxide include a monoclinic titanic acid compound given by the general formula H₂TiₙO₂ₙ₊₁ (where n is an even number of 4 or more, e.g., H₂Ti₁₂O₂₅, storage potential: 1.55 V versus Li/Li⁺), monoclinic lithium titanate given by the general formula Li₂TiₙO₂ₙ₊₁ (where n is an even number of 4 or more, e.g., Li₂Ti₁₈O₃₇ etc.), and a bronze titanium oxide (TiO₂(B), storage potential: 1.6 V versus Li/Li⁺). Examples of lithium hydrogen titanate include the above lithium titanates with a part of lithium elements replaced with hydrogen. For example, lithium hydrogen titanate is lithium hydrogen titanate given by the general formula HₓLi_{y-x}Ti_{z}O₄ (where x, y, and z are real numbers that satisfy y≧x>0, 0.8≦y≦2.7, and 1.3≦z≦2.2, e.g., HₓLi_{4/3-x}Ti_{5/3}O₄) or lithium hydrogen titanate given by the general formula H₂₋ₓLiₓTiₙO₂ₙ₊₁ (where n is an even number of 4 or more, and x is a real number that satisfies 0<x<2, e.g., H₂₋ₓLiₓTi₁₂O₂₅). In these chemical formulas, a part of lithium, titanium, and oxygen may be replaced with other element(s), and these titanium oxides may be titanium oxides with stoichiometric compositions. These titanium oxides are not limited to the titanium oxides with stoichiometric compositions, or may be titanium oxides with non-stoichiometric compositions having a deficit or excess of a part of elements. One of these titanium oxides may be used alone, or a mixture of two or more of the titanium oxides may be used. Alternatively, a titanium oxide (e.g., TiO₂) that changes to a lithium titanium composite oxide by charge and discharge may be used as an active material. These materials may be mixed as desired. The upper limit of the lithium ion storage potential of the titanium oxide is preferably, but not limited to, 2 V. Although the negative electrode may include a known negative electrode active material other than the titanium oxide, the capacity of the titanium oxide preferably accounts for 50% or more of the negative electrode capacity, and more preferably 80% or more of the negative electrode capacity.

It is preferable to use as the titanium oxide a titanium oxide selected from Li₄₊ₓTi₅O₁₂, Li₂₊ₓTi₃O₇, the titanium oxide given by the general formula H₂TiₙO₂ₙ₊₁, and the bronze titanium oxide because the dinitrile compound tends to work effectively. In these chemical formulas, x is a real number that satisfies 0≦x≦3, and n is an even number of 4 or more.

As used herein, the “lithium ion storage potential (versus Li/Li⁺)” refers to a potential corresponding to the midpoint of capacity in a potential-capacity curve for charging. This potential-capacity curve is obtained by capacity measurement in which a coin cell using lithium metal foil as a counter electrode is charged with a constant current at 0.25 C in a 25° C. environment until the cell voltage reaches 1.0 V and is then discharged with a constant current at 0.25 C in the 25° C. environment until the cell voltage reaches 3.0 V.

It is preferable that the titanium oxide have an average primary particle size of 2 μm or less. The titanium oxide having an average primary particle size of 2 μm or less has a sufficient effective area that contributes to an electrode reaction, and thus provides satisfactory large current discharge properties. The average primary particle size can be obtained as an average of the particle sizes of 100 primary particles measured with an electron scanning microscope. The primary particles may be granulated by a known method to form secondary particles. It is preferable that the average secondary particle size be 0.1 to 30 μm. The average secondary particle size can be measured by a laser diffraction/scattering method.

It is preferable that the titanium oxide have a specific surface area of 1 to 15 m²/g. The titanium oxide having a specific surface area of 1 m²/g or more has a sufficient effective area that contributes to an electrode reaction, and thus provides satisfactory large current discharge properties. Even a titanium oxide having a specific surface area of over 15 m²/g provides the effect of the present invention. However, the use of the titanium oxide having a specific surface area of over 15 m²/g may cause problems in terms of handling in manufacturing of the electrode, such as in terms of dispersion properties of the active material in negative electrode composite slurry, coating properties of the current collector with the composite slurry, and adhesion properties between the active material layer and the current collector. It is therefore preferable that the titanium oxide have a specific surface area of 15 m²/g or less. In the case of using the titanium oxide having a specific surface area as large as 5 m²/g or more, a large amount of gas is usually generated in a charge-discharge cycle or during storage of the battery. However, the use of the present invention reduces generation of gas, and in particular, significantly reduces generation of gas associated with a high temperature cycling. As a result, the titanium oxide having a large surface area can be used as the negative electrode active material, whereby a non-aqueous electrolyte secondary battery having satisfactory rapid charge and discharge properties and large current discharge properties is obtained. The specific surface area can be obtained by a single-point BET method using nitrogen adsorption.

The conductive material is used to make the negative electrode conductive. Any conductive material that does not cause a chemical change in a battery to be configured may be used as the conductive material. Examples of such a conductive material include conductive materials containing a carbon material like natural graphite, artificial graphite, carbon black, acetylene black, ketjen black, or carbon fibers, a metal material like metal powder or metal fibers such as copper, nickel, aluminum, or silver, a conductive polymer such as a polyphenylene derivative, or a mixture thereof.

For example, polytetrafluoroethylene (PTFE), polyvinylidene fluoride (PVdF), fluororubber, styrene-butadiene rubber (SBR), carboxymethyl cellulose (CMC), etc. can be used as the binder.

Various known additives may be contained in the negative electrode active material layer as other material. A dinitrile compound and/or a reaction product thereof may be contained in the negative electrode.

It is preferable that the negative electrode active material layer contain 70 to 95 mass % of the negative electrode active material, 0 to 25 mass % of the conductive material, and 2 to 10 mass % of the binder.

The negative electrode can be produced by suspending the negative electrode active material, the conductive material, and the binder in an appropriate solvent to prepare slurry, coating one or both surfaces of the current collector with the slurry, and drying the coating.

A liquid non-aqueous electrolyte (non-aqueous electrolyte solution) that is prepared by dissolving a lithium salt in a non-aqueous solvent and that contains a dinitrile compound and/or a reaction product of the dinitrile compound is used as the non-aqueous electrolyte solution.

A non-aqueous electrolyte secondary battery that reduces generation of gas associated with a high temperature cycling and reduces capacity deterioration of the battery and that has excellent rapid charge and discharge properties is provided by using the non-aqueous electrolyte solution containing a dinitrile compound and/or a reaction product of the dinitrile compound for the negative electrode that includes an active material containing a titanium oxide.

The dinitrile compound is not particularly limited, and may be any organic dinitrile compound. In particular, a dinitrile compound, namely a chain saturated hydrocarbon compound having nitrile groups bonded to both terminals thereof, which is given by the structural formula CN—(CH₂)ₙ—CN (where n≧1 and n is an integer), is preferable as this dinitrile compound easily dissolves in the electrolyte solution and the effect of the present invention is easily obtained. In particular, in view of availability and cost, any of dinitrile compounds of n=about 1 to 10, namely any of malononitrile (n=1), succinonitrile (n=2), glutaronitrile (n=3), adiponitrile (n=4), pimelonitrile (n=5), suberonitrile (n=6), azelanitrile (n =7), sebaconitrile (n=8), undecanenitrile (n=9), and dodecanenitrile (n=10), is preferred, and malononitrile, succinonitrile, glutaronitrile, or adiponitrile is particularly preferred. Succinonitrile is more preferable as it particularly easily dissolves in the electrolyte solution and the effect of the present invention is easily obtained.

For example, the reaction product of the dinitrile compound is a material that is produced by a reaction of the dinitrile compound in the battery through charge and discharge, storage, etc. of the non-aqueous electrolyte secondary battery. Although the inventors have not been able to specify the species of these compounds, the inventors have inferred that these compounds should be present as decomposed materials or polymers resulting from oxidation, reduction, or thermal reaction, polymers of dinitrile compounds, or reactants with other materials, etc. In particular, these compounds should mainly contain a material that is oxidatively decomposed on the surface of the positive electrode. The presence of the dinitrile compound and/or the reaction product thereof can be verified by a carbon-nitrogen bond that is observed when the dried electrolyte or the surface of the active material is analyzed by X-ray photoelectron spectroscopy (XPS).

In the non-aqueous electrolyte secondary battery of the present invention, it is preferable that the total content of the dinitrile compound and/or the reaction product thereof in the non-aqueous electrolyte solution be 1 mass % to 5 mass %. If the total content of the dinitrile compound and/or the reaction product thereof is less than 1 mass %, the effect of adding the dinitrile compound and/or the reaction product thereof is not obtained. If the total content of the dinitrile compound and/or the reaction product thereof is more than 5 mass %, charge and discharge properties are reduced probably because a thick coating film is formed on the surface of the active material. That is, in the non-aqueous electrolyte secondary battery of the present invention, setting the total content of the dinitrile compound and/or the reaction product thereof in the non-aqueous electrolyte solution to 1 mass % to 5 mass % allows reduction in generation of gas associated with a high temperature cycling and reduction in capacity deterioration of the battery as well as excellent rapid charge and discharge properties to be achieved at a high level. It is more preferable that the total content of the dinitrile compound and/or the reaction product thereof in the non-aqueous electrolyte solution be 1 mass % to 3 mass %.

A non-aqueous organic solvent is used as the non-aqueous solvent and serves as a medium in which ions involved in an electrochemical reaction of a lithium battery can move. Examples of such a non-aqueous organic solvent include a carbonate solvent, an ester solvent, an ether solvent, a ketone solvent, an alcohol solvent, and an aprotic solvent. Dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), etc. can be used as the carbonate solvent.

Methyl acetate, ethyl acetate, n-propyl acetate, dimethyl acetate, methyl propionate, ethyl propionate, γ-butyrolactone (GBL), decanolide, valerolactone, mevalonolactone, caprolactone, etc. can be used as the ester solvent.

Dibutyl ether, tetraglyme, diglyme, dimethoxyethane, 2-methyltetrahydrofuran, tetrahydrofuran, etc. can be used as the ether solvent.

Cyclohexanone etc. can be used as the ketone solvent.

Ethyl alcohol, isopropyl alcohol, etc. can be used as the alcohol solvent.

Nitriles such as R—CN (where R represents a C2 to C20 linear, branched, or cyclic hydrocarbon group, and may include a double bond, an aromatic ring, or an ether bond), amides such as dimethylformamide, dioxolanes such as 1,3-dioxolane, sulfolanes, etc. can be used as the aprotic solvent.

The non-aqueous organic solvent may consist of a single material or may be a mixture of two or more solvents. In the case where the non-aqueous organic solvent is a mixture of two or more solvents, the mixing ratio of the two or more solvents is appropriately adjusted according to battery performance. For example, a non-aqueous solvent mainly containing a cyclic carbonate such as EC and PC or mainly containing a mixed solvent of a cyclic carbonate and a non-aqueous solvent having lower viscosity than the cyclic carbonate, etc. can be used. The cyclic carbonate may be a mixture of a plurality of cyclic carbonates. For example, the cyclic carbonate may be a mixture of EC and PC. The non-aqueous solvent having lower viscosity than the cyclic carbonate may be a chain carbonate. For example, the non-aqueous solvent having lower viscosity than the cyclic carbonate may be EMC.

As a specific mixing example of the non-aqueous organic solvent, it is preferable to use a solvent containing at least three components (a) to (c), namely (a) ethylene carbonate, (b) cyclic carboxylic acid ester, or cyclic carbonate having four or more carbon atoms, and (c) chain carbonate. It is more preferable that the content of (a) ethylene carbonate in the entire non-aqueous solvent be 5 to 20 vol %. It is more preferable that the content (vol %) of the component (b) in the entire non-aqueous solvent be equal to or higher than that of the component (a) in the entire non-aqueous solvent, and it is further preferable that the content (vol %) of the component (c) in the entire non-aqueous solvent is be higher than the sum of the content of the component (a) and the content of the component (b) in the entire non-aqueous solvent. This reduces generation of gas associated with a high temperature cycling and reduces capacity deterioration of the battery, and achieves sufficient low-temperature charge and discharge properties.

Examples of the lithium salt include lithium hexafluorophosphate (LiPF₆), lithium tetrafluoroborate (LiBF₄), lithium hexafluoroarsenate (LiAsF₆), lithium perchlorate (LiClO₄), lithium bis(trifluoromethanesulfonyl)imide (LiN(CF₃SO₂)₂, LiTSFI), and lithium trifluoromethanesulfonate (LiCF₃SO₃). One of these lithium salts may be used alone, or a mixture of two or more of the lithium salts may be used.

In particular, it is preferable that the non-aqueous electrolyte solution contain lithium hexafluorophosphate (LiPF₆) or lithium tetrafluoroborate (LiBF₄) as the lithium salt, and it is more preferable that the non-aqueous electrolyte solution contain both lithium hexafluorophosphate (LiPF₆) and lithium tetrafluoroborate (LiBF₄) as the lithium salts. This configuration further reduces capacity deterioration of the battery associated with a high temperature cycling and further improves rapid charge and discharge properties. This is because a protective film with high ion conductivity formed on the negative electrode by the dinitrile compound is stabilized by lithium tetrafluoroborate and ion conduction in the electrolyte solution is increased by lithium hexafluorophosphate. In particular, capacity deterioration of the battery associated with a high temperature cycling is further reduced by combining this configuration with conditioning described below.

It is preferable that the concentration of the lithium salt in the non-aqueous solvent be 0.5 to 2.5 mol/l. The concentration of 0.5 mol/l or more reduces ion conduction resistance of the non-aqueous electrolyte and improves charge and discharge properties. The concentration of 2.5 mol/l or less reduces an increase in melting point or viscosity of the non-aqueous electrolyte and allows the non-aqueous electrolyte to be in a liquid form at normal temperature.

In the case where the non-aqueous electrolyte solution contains both LiPF₆ and LiBF₄ as the lithium salts, it is preferable that the molar concentration of LiPF₆ be higher than that of LiBF₄. It is more preferable that the molar concentration of LiBF₄ be 0.001 to 0.5 mol/l, and more preferably 0.001 to 0.2 mol/l. This molar concentration range further reduces capacity deterioration of the battery associated with a high temperature cycling probably because the protective film with high ion conductivity formed on the negative electrode by the dinitrile compound and/or the reaction product thereof is appropriately stabilized by lithium tetrafluorob orate.

The non-aqueous electrolyte solution may further contain an additive that improves low-temperature properties etc. of the lithium battery. For example, a carbonate material, ethylene sulfite (ES), or 1,3-propanesultone (PS) can be used as the additive.

For example, the carbonate material may be selected from the group consisting of vinylene carbonate (VC), a vinylene carbonate derivative having one or more substituents selected from the group consisting of a halogen (e.g., —F, —Cl, —Br, —I, etc.), a cyano group (—CN), and a nitro group (—NO₂), and an ethylene carbonate derivative having one or more substituents selected from the group consisting of a halogen (e.g., —F, —Cl, —Br, —I, etc.), a cyano group (—CN), and a nitro group (—NO₂).

Either one material or a mixture of two or more materials may be used as the additive. Specifically, the non-aqueous electrolyte solution may further contain one or more additives selected from the group consisting of vinylene carbonate (VC), fluoroethylene carbonate (FEC), ethylene sulfite (ES), and 1,3-propanesultone (PS).

It is preferable that the non-aqueous electrolyte solution contain at least one selected from vinylene carbonate (VC), ethylene sulfite (ES), and 1,3-propanesultone (PS) as the additive. These materials should serve to form a stable coating film on the titanium oxide of the negative electrode when used in combination with the dinitrile compound. This further enhances the effect of the present invention, namely further reduces generation of gas under high temperature environment.

It is preferable that the content of the additive be 10 parts by mass or less, and more preferably 0.1 to 10 parts by mass, per 100 parts by mass of the total amount of the non-aqueous organic solvent and the lithium salt. This content range improves properties of the battery under high temperature environment. The content of the additive is more preferably 1 to 5 parts by mass.

As shown in FIG. 2, the positive electrode 2 includes at least a positive electrode current collector 2a and a positive electrode active material layer 2b. The positive electrode active material layer is formed on one or both surfaces of the positive electrode current collector. The positive electrode active material layer contains at least a positive electrode active material and may contain a conductive material, a binder, or other material as necessary. For example, aluminum or an aluminum alloy can be used for the positive electrode current collector.

A known electrode active material that can function as a positive electrode for the titanium oxide used as a negative electrode active material may be used as the positive electrode active material. Specifically, any electrode active material having a lithium ion storage potential of 1.6 V or higher (versus Li/Li⁺) may be used as the positive electrode active material. Various oxides and sulfides may be used as such an active material. Examples of such oxides and sulfides include manganese dioxide (MnO₂), iron oxide, copper oxide, nickel oxide, a lithium manganese composite oxide (e.g., LiₓMn₂O₄ or LiₓMnO₂), a lithium nickel composite oxide (e.g., LiₓNiO₂), a lithium cobalt composite oxide (LiₓCoO₂), a lithium nickel cobalt composite oxide (e.g., LiₓNi_{1-y}Co_{y}O₂), a lithium manganese cobalt composite oxide (LiₓMn_{y}Co_{1-y}O₂), a lithium nickel manganese cobalt composite oxide (LiₓNi_{y}Mn_{z}Co_{1-y-z}O₂), a lithium manganese nickel composite oxide with a spinel structure (LiₓMn_{2-y}Ni_{y}O₄), a lithium phosphorus oxide with an olivine structure (LiₓFePO₄, LiₓFe_{1-y}Mn_{y}PO₄, LiₓCoPO₄, LiₓMnPO₄, etc.), a lithium silicon oxide (Li₂ₓFeSiO₄ etc.), iron sulfate (Fe₂(SO₄)₃), vanadium oxide (e.g., V₂O₅), and a solid solution composite oxide given by xLi₂MO₃.(1−x)LiM′O₂ (where M and M′ represent one or more metal elements of the same or different kinds). These materials may be mixed as desired. In the above chemical formulas, it is preferable that x, y, and z be in the range of 0 to 1.

Organic and inorganic materials such as a conductive polymer material like polyaniline and polypyrrole, a disulfide polymer material, sulfur (S), and fluorocarbon may be used as the positive electrode active material.

Among the above positive electrode active materials, it is preferable to use an active material having a high lithium ion storage potential. For example, a lithium manganese composite oxide with a spinel structure (LiₓMn₂O₄), a lithium nickel composite oxide (LiₓNiO₂), a lithium cobalt composite oxide (LiₓCoO₂), a lithium nickel cobalt composite oxide (LiₓNi_{1-y}Co_{y}O₂), a lithium manganese cobalt composite oxide (LiₓMn_{y}Co_{1-y}O₂), a lithium manganese nickel composite oxide with a spinel structure (LiₓMn_{2-y}Ni_{y}O₄), lithium iron phosphate (LiₓFePO₄), etc. are preferably used, and in particular, a lithium manganese composite oxide with a spinel structure and lithium iron phosphate are preferably used. In the above chemical formulas, it is preferable that x, y, and z be in the range of 0 to 1.

For example, acetylene black, carbon black, graphite, etc. can be used as the conductive material.

For example, polytetrafluoroethylene (PTFE), polyvinylidene fluoride (PVdF), fluororubber, styrene-butadiene rubber (SBR), carboxymethyl cellulose (CMC), etc. can be used as the binder.

Other materials that can be contained in the positive electrode active material layer include various additives. For example, vinylene carbonate, 1,3-propanesultone, etc. can be used. A dinitrile compound and/or a reaction product thereof can be contained in the positive electrode.

It is preferable that the positive electrode active material layer contain 80 to 95 mass % of the positive electrode active material, 3 to 18 mass % of the conductive material, and 2 to 10 mass % of the binder.

The positive electrode can be produced by suspending the positive electrode active material, the conductive material, and the binder in an appropriate solvent to prepare slurry, coating one or both surfaces of the current collector with the slurry, and drying the coating.

The separator is placed between the positive electrode and the negative electrode to prevent the positive and negative electrodes from contacting each other. The separator is made of an insulating material. The separator is shaped so as to allow an electrolyte to move between the positive and negative electrodes.

Examples of the separator include a synthetic resin nonwoven fabric, a porous polyethylene film, a porous polypropylene film, and a cellulose-based separator.

The packaging member may be a laminated film or a metal container. A multilayer film made of metal foil covered with a resin film is used as the laminated film. A resin for the resin film may be a polymer such as polypropylene (PP), polyethylene (PE), nylon, or polyethylene terephthalate (PET). The inner surface of the packaging member made of the laminated film is comprised of a thermoplastic resin such as PP or PE.

It is preferable that the laminated film have a thickness of 0.2 mm or less.

The non-aqueous electrolyte secondary battery of the present invention may be configured so that charge capacity of the battery is regulated by the negative electrode. With this configuration, a non-aqueous electrolyte secondary battery is provided which further reduces generation of gas associated with a high temperature cycling and further reduces capacity deterioration of the battery and which has improved rapid charge and discharge properties.

In order to prevent deposition of the metal lithium during charging of the battery, in conventional non-aqueous electrolyte batteries using a negative electrode active material having a low lithium ion storage potential such as a carbon material, the negative electrode is made to have larger capacity than the positive electrode so that the capacity of the battery is regulated by the positive electrode. On the other hand, in the case where the ratio of the negative electrode capacity to the positive electrode capacity is set so that the capacity of the battery is regulated by the negative electrode, particularly in the case where charging of the battery is regulated by the negative electrode, as in (3) of the present invention, the positive electrode is maintained at a relatively low potential when the battery is in normal use. A coating film is therefore less likely to be formed on the positive electrode by an oxidation reaction of the dinitrile compound. Accordingly, the dinitrile compound added to the non-aqueous electrolyte solution would be appropriately distributed to the positive electrode and the negative electrode including the titanium oxide and act on each electrode, thereby reducing reductive decomposition of the electrolyte solution on the negative electrode and sufficiently reducing generation of gas. Since the potential of the positive electrode does not become too high, oxidative decomposition of the electrolyte solution would be less likely to occur, reducing generation of gas on the positive electrode. At the same time, since the potential of the positive electrode does not become too high, degradation of the crystal structure of the positive electrode active material itself would be reduced, thereby further reducing generation of gas associated with a high temperature cycling and further reducing capacity deterioration of the battery.

In particular, it is preferable that the ratio of the negative electrode capacity to the positive electrode capacity, R=N/P, satisfies 0.7≦R≦1.0, where P represents actual capacity of the positive electrode, and N represents actual capacity of the negative electrode. Even if R is smaller than 0.7, the effect of the present invention can still be obtained, but discharge capacity as the battery is reduced. The values P, N can be obtained as follows.

The positive electrode and the lithium metal foil which are shaped so as to be used in a coin cell are placed to face each other with a separator therebetween in dry argon. These members are placed in a coin cell, an electrolyte solution is introduced into the coin cell, and the coin cell is sealed with the separator and the electrode being sufficiently impregnated with the electrolyte solution. A solution of 1.0 mol/l of LiPF₆ as an electrolyte in a mixed solvent of ethylene carbonate (EC) and dimethyl carbonate (DMC) with the EC/DMC volume ratio of 1:2 is used as the electrolyte solution. The coin cell thus produced is charged with a constant current at 0.25 C in a 25° C. environment until the cell voltage reaches 4.2 V and is then discharged with a constant current at 0.25 C in the 25° C. environment until the cell voltage reaches 3.0 V. Capacity at the time of the discharge is divided by the area of a positive electrode active material layer of the coin cell to calculate actual capacity P (mAh/cm²) in the 25° C. environment per unit area of the positive electrode. The temperature environment for measurement of the actual capacity is created by using an incubator (IN804 Incubator made by Yamato Scientific Co., Ltd.) etc.

Another coin cell is produced by a method similar to that described above except that the negative electrode shaped so as to be used in the coin cell is used instead of the positive electrode. The coin cell produced is charged with a constant current at 0.25 C in a 25° C. environment until the cell voltage reaches 1.0 V and is then discharged with a constant current at 0.25 C in the 25° C. environment until the cell voltage reaches 3.0 V. Capacity at the time of the discharge is divided by the area of a negative electrode active material layer of the coin cell to calculate actual capacity N (mAh/cm²) in the 25° C. environment per unit area of the negative electrode. In the measurement of N, charging refers to the case where lithium ions are stored in the active material, and discharging refers to the case where lithium ions are released from the active material.

A method for manufacturing a non-aqueous electrolyte secondary battery according to (14) of the present invention will be described below. This method comprises the steps of placing in a packaging member a positive electrode, a negative electrode that includes an active material containing a titanium oxide having a lithium ion storage potential of 1.2 V or higher (versus Li/Li⁺), and a non-aqueous electrolyte solution that contains at least a lithium salt, a non-aqueous solvent, and a dinitrile compound, and sealing an opening of the packaging member to produce a sealed secondary battery; and charging the sealed secondary battery. The non-aqueous electrolyte secondary battery of the present invention is manufactured in this manner. This method will be described in detail below together with a method for manufacturing a non-aqueous electrolyte secondary battery comprising the step of conditioning the battery.

It is preferable that the method for manufacturing a non-aqueous electrolyte secondary battery according to the invention comprises the following step of conditioning the battery. This method comprises the steps of placing in a packaging member a positive electrode, a negative electrode that includes an active material containing a titanium oxide having a lithium ion storage potential of 1.2 V or higher (versus Li/Li⁺), and a non-aqueous electrolyte solution that contains at least a lithium salt, a non-aqueous solvent, and a dinitrile compound, and temporarily sealing an opening of the packaging member to produce a temporarily sealed secondary battery; adjusting a negative electrode potential of the temporarily sealed secondary battery to a potential higher than 0.8 V and equal to or lower than 1.4 V (versus Li/Li⁺) and storing the temporarily sealed secondary battery in an atmosphere of 50° C. or higher and lower than 80° C.; and opening the temporarily sealed secondary battery to discharge gas therefrom, and then finally sealing the packaging member.

Adopting such conditioning in the method for manufacturing a battery comprising a negative electrode that includes an active material containing a titanium oxide and a non-aqueous electrolyte solution that contains a dinitrile compound further reduces generation of gas associated with a high temperature cycling. The mechanism of how adopting such conditioning works to further reduce generation of gas is not clear, and this mechanism does not limit the present invention, but the inventors have made the following inference. Water, carbon dioxide, etc. have been adsorbed on the surface of the titanium oxide. These impurities tend to be released as gas if the negative electrode potential is made lower than the lithium ion storage potential, i.e., if the battery is further charged even after the SOC reaches 100%. If the battery is stored at a high temperature, the dinitrile compound is more sufficiently decomposed to form a satisfactory coating film. In the case where the non-aqueous electrolyte solution contains the carbonate material, ethylene sulfite (ES), or 1,3-propanesultone (PS) as an additive, the additive is also easily decomposed, and together with the dinitrile compound, forms a satisfactory coating film. In particular, initially charging the battery so that the negative electrode potential becomes equal to or lower than 1.4 V (versus Li/Li⁺) and storing the battery at a high temperature facilitates desorption of the absorbed water, carbon dioxide, etc. In this state, the dinitrile compound and/or the reaction product thereof acts on the surface of the negative electrode, or some sort of coating film is formed on the surface of the negative electrode. This further enhances the effect of the present invention, namely further reduces generation of gas.

(First Step)

A temporarily sealed secondary battery is produced in a first step. An electrode group is first placed in a packaging member. The electrode group is formed by a positive electrode, a negative electrode, and a separator. Specifically, for example, a positive electrode, a separator, a negative electrode, and a separator are sequentially stacked on each other and the stack is wound into a flat shape to form a flat electrode group. In another method, for example, one or more sets of a positive electrode and a negative electrode may be stacked on each other with a separator between the positive and negative electrodes to form an electrode group. An insulating tape may be wound around the electrode group to fix the electrode group as necessary. The step of heating and/or vacuum drying the electrode group and each constituent member to reduce adsorbed water may be added after and/or before formation of the electrode group.

As shown in FIGS. 1 and 2, a belt-like positive electrode terminal 7 is electrically connected to the positive electrode 2. A belt-like negative electrode terminal 8 is electrically connected to the negative electrode 3. The positive and negative electrode terminals may be formed integrally with the positive and negative electrode current collectors, respectively. Alternatively, a terminal formed separately from the current collector may be connected to the current collector. The positive and negative electrode terminals may be respectively connected to the positive and negative electrodes before the stack is wound. Alternatively, the positive and negative electrode terminals may be respectively connected to the positive and negative electrodes after the stack is wound.

The packaging member made of a laminated film can be formed by bulging or deep drawing the laminated film from the thermoplastic resin film side to form a cup-shaped electrode group packing portion, and then bending the laminated film 180° with the thermoplastic resin film side facing inward so as to form a lid. For example, in the case where the packaging member is a metal container, the packaging member can be formed by drawing a metal sheet. An example of using the packaging member made of a laminated film will be described below as a representative example.

The electrode group is placed in the electrode group packing portion of the packaging member, and the positive and negative electrode terminals are extended to the outside of the container. Then, the upper end of the packaging member from which the positive and negative electrode terminals are extended to the outside and one of those ends of the packaging member which are perpendicular to the upper end are heat sealed to form a sealed portion. The packaging member having an opening along its one side is formed in this manner. The step of heating and/or vacuum drying each constituent member to reduce adsorbed water may be added at this time.

Subsequently, a non-aqueous electrolyte solution is introduced into the packaging member through the opening to impregnate the electrode group with the non-aqueous electrolyte solution. In order to facilitate impregnation of the electrode group with the electrolyte solution, the battery may be stored while being pressed in the thickness direction thereof, or the non-aqueous electrolyte solution may be introduced into the packaging member after the internal pressures of the electrodes are reduced.

Thereafter, the opening is heat sealed to form a temporarily sealed portion to produce a temporarily sealed secondary battery sealing the electrode group and the non-aqueous electrolyte with which the electrode group has been impregnated. In the case where conditioning is not performed, the heat sealing of the opening serves as final sealing to produce a finally sealed battery.

(Second Step)

Subsequently, a second step is performed. A current is applied between the positive and negative electrode terminals of the temporarily sealed secondary battery to initially charge the temporarily sealed secondary battery so that the negative electrode potential becomes higher than 0.8 V and equal to or lower than 1.4 V (versus Li/Li⁺). It is more preferable to initially charge the temporarily sealed secondary battery so that the negative electrode potential becomes lower than the lithium ion storage potential of the negative electrode active material by 350 mV or more.

It is preferable to initially charge the battery so that the negative electrode potential becomes equal to or lower than 1.2 V (versus Li/Li⁺), because this further reduces generation of gas associated with the use of the battery under high temperature environment and further reduces capacity deterioration of the battery. It is not preferable to initially charge the battery so that the negative electrode potential becomes equal to or lower than 0.8 V (versus Li/Li⁺). This would excessively form a coating film on the surface of the negative electrode, reducing discharge capacity of the battery. In the case of using aluminum for the negative electrode current collector, it is not preferable to reduce the negative electrode potential to 0.4 V or less (versus Li/Li⁺) because aluminum of the current collector forms an alloy with lithium.

The period between production of the temporarily sealed secondary battery and initial charge is not particularly limited and may be set to any period according to the production schedule etc. For example, this period may be an hour to a month. The initial charge of the battery and storage of the battery at a high temperature described below are not limited to the first charge after production of the temporarily sealed secondary battery. The initial charge of the battery and the storage of the battery at a high temperature may be performed after the battery is charged and discharged and stored one or more times, as long as the battery can be subsequently opened to discharge gas therefrom.

For example, the negative electrode potential can be adjusted by calculating in advance such an amount of charge electricity that the negative electrode potential becomes equal to a desired potential higher than 0.8 V and equal to or lower than 1.4 V (versus Li/Li⁺) in a cell of the same battery configuration by using reference electrodes, and charging the temporarily sealed battery with the calculated amount of electricity. Alternatively, the negative electrode potential can be adjusted by charging the cell of the same battery configuration under the same conditions until the negative electrode potential becomes equal to a desired potential higher than 0.8 V and equal to or lower than 1.4 V (versus Li/Li⁺) by using the reference electrodes, checking the cell voltage at this time, and using the checked cell voltage value as an initial charge cut-off voltage for the temporarily sealed battery. Another method is as follows. A coin cell is produced by cutting out as a working electrode a positive electrode for a non-aqueous electrolyte secondary battery and using a counter electrode made of metal lithium foil and the same electrolyte solution and the same separator as those of the battery. This coin cell is charged under the same conditions of C rate and temperature as those for initial charge of the battery to obtain a charge curve with the ordinate representing the potential and the abscissa representing the capacity. For the negative electrode as well, a potential-capacity curve on the lithium ion storage side including a desired negative electrode potential is obtained by a method according to the evaluation of the positive electrode by using as a working electrode a negative electrode cut out with the same dimensions as those for the evaluation of the positive electrode. The potential-capacity curves thus obtained for the positive and negative electrodes are superimposed on each other in a single graph. The potential of the positive electrode which corresponds to the capacity at the time the negative electrode reaches the desired negative electrode potential is read from this graph, and a cell voltage is obtained from the potential difference between the positive and negative electrodes. This cell voltage is used as an initial charge cut-off voltage.

In the case of using a lithium manganese composite oxide with a spinel structure as the positive electrode active material, it is preferable to adjust the negative electrode potential of the temporarily sealed battery so that the cell voltage becomes equal to 2.8 to 3.4 V, and more preferably 3.0 to 3.4 V. In the case of using lithium iron phosphate as the positive electrode active material, it is preferable to adjust the negative electrode potential of the temporarily sealed battery so that the cell voltage becomes equal to 2.1 to 2.7 V, and more preferably 2.3 to 2.7 V.

Although the temperature at which initial charge is carried out can be set as desired, this temperature is preferably about 20 to 45° C. and may be normal temperature (20 to 30° C.). It is preferable to carry out initial charge at normal temperature because facilities can be simplified.

A charge current value can be set as desired. When the charge current value is 1 C or less, the effect of the present invention is easily obtained. Namely, generation of gas under high temperature environment is easily reduced. It is preferable to set the charge current value to 0.5 C or less. The current value may be changed during charging. For example, CC-CV charging may be performed. The 1 C capacity may be equal to nominal capacity of the battery.

If the temporarily sealed secondary battery has a substantially flat shape, the initial charge may be performed while pressing the battery body in the thickness direction thereof. The pressing method is not particularly limited. For example, the initial charge may be performed with the battery being pressed, or the initial charge may be performed with the battery being placed in a holder capable of fixing the battery so as to be in contact with the front and back surfaces of the battery. Charge conditions in the step of charging the sealed secondary battery according to (14) of the present invention are not particularly limited, but the charging conditions described in (15) of the present invention are preferably used.

Thereafter, the temporarily sealed secondary battery initially charged to the negative electrode potential is stored in an atmosphere of 50° C. or higher and lower than 80° C.

Storing the temporarily sealed secondary battery at an ambient temperature lower than 50° C. is not industrially practical as it takes time for water, carbon dioxide, etc. to be released from the electrode group. Moreover, it results in the battery with insufficient high temperature properties because an appropriate coating film would be less likely to be formed on the surface of the negative electrode. In the case of storing the temporarily sealed secondary battery at an ambient temperature equal to or higher than 80° C., the non-aqueous electrolyte tends to react at the surfaces of the positive and negative electrodes. A coating film would therefore be excessively formed, reducing discharge capacity of the battery and reducing the capacity retention to a large extent in a high temperature cycling. The ambient temperature is more preferably in the range of 50 to 70° C.

The temporarily sealed secondary battery may be stored in an atmosphere of 50° C. or higher and lower than 80° C. for any time period as long as gas is sufficiently released from the negative electrode. This storage period may be, e.g., 5 hours to 10 days, and preferably 1 to 8 days, although it is not limited to this. The storage period may be adjusted according to the species of the positive electrode active material. For example, in the case of using a lithium-transition metal composite oxide as the positive electrode active material, the storage period may be 5 hours to 5 days, and preferably 1 to 4 days. For example, in the case of using lithium iron phosphate as the positive electrode active material, the storage period may be 5 hours to 10 days, and preferably 5 to 8 days. The period between initial charge and the start of high temperature storage is not particularly limited, and may be set as desired.

If the temporarily sealed secondary battery is in an open circuit state during the period of high temperature storage, the negative electrode potential increases due to self-discharge. If the battery is substantially continuously charged during storage so that the battery is stored with a constant potential, the battery capacity decreases significantly after storage. It is therefore preferable not to store the battery with a constant potential. For example, it is preferable not to trickle charge or float charge the battery. In order to compensate for a part of self-discharge capacity, the battery may be intermittently charged with about 10% of the self-discharge amount during the storage. However, it is most preferable that the battery be stored in the open circuit state.

As used herein, the expression “the negative electrode potential of the temporarily sealed secondary battery is adjusted to a potential higher than 0.8 V and equal to or lower than 1.4 V, and the temporarily sealed secondary battery is stored in an atmosphere of 50° C. or higher and lower than 80° C.” does not mean that the negative electrode potential need be retained in this range during the period of high temperature storage, but includes the case where the negative electrode potential increases to a value out of this potential range during the storage period as long as the negative electrode potential as the charge cut-off potential is in this potential range. The effect of the present invention can be obtained even in this case.

(Third Step)

Subsequently, a part of the packaging member is cut or a hole is cut in the packaging member to discharge the gas staying in the packaging member in the second step to the outside. For example, the packaging member may be opened by cutting the laminated film at any position in its opening portion that is a non-heat-sealed portion located inside the temporarily sealed portion. It is preferable to open the packaging member under a reduced pressure, and it is preferable to open the packaging member in an inert atmosphere or in dry air.

After the packaging member is opened, the non-aqueous electrolyte secondary battery may be placed under a reduced pressure atmosphere by using a reduced pressure chamber etc., or gas may be sucked from the opened part or the hole of the packaging member by using a suction nozzle. The gas in the packaging member is more reliably discharged by these methods.

After the gas is discharged, the packaging member is heat sealed at a position inside the cut part of the opening portion to form a final sealed portion, thereby sealing the electrode group and the non-aqueous electrolyte solution again. Moreover, the packaging member is cut at a position outside the final sealed portion to cut off the opening portion. The non-aqueous electrolyte secondary battery is thus produced. At this time, it is preferable to seal the electrode group and the non-aqueous electrolyte solution under a reduced pressure. Alternatively, the electrode group and the non-aqueous electrolyte solution may be sealed by attaching an adhesive tape etc. to a region having the hole in the packaging member. Even if conditioning is not performed, the packaging member may be opened to discharge gas and may be sealed again after the step of charging the battery.

The non-aqueous electrolyte secondary battery thus produced may be charged and discharged one or more times as desired. The non-aqueous electrolyte secondary battery may further be stored at normal temperature or a high temperature. A conditioning process (the second step or the second and third steps) may be performed a plurality of times.

The present invention will be specifically described below based on examples.

### Experiment 1

### Example 1

### Production of Working Electrode

Powder of lithium titanate with a spinel structure (Li₄Ti₅O₁₂, granules of lithium ion storage potential: 1.55 V versus Li/Li⁺, specific surface area: 10.9 m²/g, average secondary particle size: 7.4 μm, average primary particle size: 0.8 μm) as an active material was mixed with acetylene black as a conductive material. Then, a solution of polyvinylidene fluoride (PVdF) in N-methylpyrrolidone (NMP) was added to the mixture and mixed together. NMP was added to the mixed solution, and the resultant solution was then stirred at 2,000 rpm for 3 minutes and defoamed at 2,200 rpm for 30 seconds with a stirring/defoaming apparatus (THINKY MIXER made by THINKY CORPORATION). The defoaming was performed twice. Thereafter, the resultant solution was stirred at 2,000 rpm for 5 minutes and defoamed at 2,200 rpm for 30 seconds. This time, the defoaming was performed only once. Composite slurry was prepared in this manner. The mass ratio of Li₄Ti₅O₁₂:acetylene black PVdF was 89.3:4.5:6.2. Thereafter, one surface of a current collector made of aluminum foil and having a thickness of 20 μm was coated with the prepared composite slurry so that the amount of active material was 3.0 mg/cm². The resultant coated current collector was dried and then pressed to a composite density of 1.8 to 2.0 g/cm³, and the electrode material was cut into a circular shape with a diameter of 12 mm to produce a working electrode. The working electrode thus produced was then dried under a reduced pressure at 130° C. for 8 hours. The average secondary particle size of the active material was measured by laser diffractometry (laser diffraction/scattering type particle size distribution measuring apparatus LA-950 made by HORIBA, Ltd.), and the average primary particle size thereof was obtained by electron microscopy (scanning electron microscope S-4800 made by Hitachi High-Technologies Corporation, an average of 100 primary particles). The specific surface area of the active material was measured by a single-point BET method using nitrogen adsorption by using a specific surface area measuring apparatus (Monosorb made by Quantachrome Instruments).

<Preparation of Non-Aqueous Electrolyte Solution>1 mol/l of lithium tetrafluoroborate (LiBF₄) as a lithium salt was dissolved in a mixed solvent of ethylene carbonate (EC), propylene carbonate (PC), and methyl ethyl carbonate (MEC) (EC/PC/MEC volume ratio of 1:3:6), and 2 mass % of succinonitrile as an additive was further dissolved in the resultant solution to prepare a non-aqueous electrolyte solution. This will be referred to as the non-aqueous electrolyte solution A.

<Production of Evaluation Cell>

This working electrode was incorporated in a sealable coin-type evaluation cell in a glove box with a dew point of −70° C. or lower. The evaluation cell used was made of stainless steel (SUS316) and had an outer diameter of 20 mm and a height of 3.2 mm. A counter electrode used (which also served as a reference electrode) was obtained by forming metal lithium foil having a thickness of 0.5 mm into a circle having a diameter of 12 mm. The working electrode produced as described above was placed in a lower case of the evaluation cell, and a microporous polypropylene film having a thickness of 20 μm and the metal lithium foil were sequentially stacked thereon in this order so that a composite layer of the working electrode faces the metal lithium foil with a separator therebetween. Thereafter, a non-aqueous electrolyte solution was dropped thereon so that the electrode group was impregnated with the non-aqueous electrolyte solution. A 0.5 mm-thick spacer for thickness adjustment and a spring (both made of SUS316) were placed thereon. An upper case having a gasket made of polypropylene was placed thereon, and the outer peripheral edges of the upper and lower cases were crimped to seal the evaluation cell. The evaluation cell was thus assembled. Designed capacity was 0.497 mAh.

The cell thus assembled was left for 3 hours. A current was then applied between a working electrode terminal and a counter electrode terminal of the cell at 0.25 C (0.124 mA) to charge the cell at 25° C. until the cell voltage reached 1 V. Thereafter, a current was applied at 0.25 C (0.124 mA) to discharge the cell at 25° C. until the cell voltage reached 3 V. This charge and discharge process was performed twice, and the resultant cell was used as the evaluation cell. In Experiment 1, charging refers to the case where lithium ions are stored in lithium titanate.

### Example 2

1 mol/l of lithium hexafluorophosphate (LiPF₆) and 0.2 mold of lithium tetrafluoroborate (LiBF₄) as lithium salts were dissolved in a mixed solvent of ethylene carbonate (EC), propylene carbonate (PC), and methyl ethyl carbonate (MEC) (EC/PC/MEC volume ratio of 1:3:6), and 2 mass % of succinonitrile as an additive was further dissolved in the resultant solution to prepare a non-aqueous electrolyte solution. This will be referred to as the non-aqueous electrolyte solution B. An evaluation cell was produced by a method similar to that of Example 1 except that the non-aqueous electrolyte solution B was used.

### Comparative Example 1

1 mol/l of lithium hexafluorophosphate (LiPF₆) as an electrolyte was dissolved in a mixed solvent of ethylene carbonate (EC), propylene carbonate (PC), and methyl ethyl carbonate (MEC) (EC/PC/MEC volume ratio of 1:3:6) to prepare a non-aqueous electrolyte solution. This will be referred to as the non-aqueous electrolyte solution C. An evaluation cell was produced by a method similar to that of Example 1 except that the non-aqueous electrolyte solution C was used.

<Evaluation of Charge and Discharge Properties>

Charge and discharge properties of the evaluation cells of Examples 1, 2 and Comparative Example 1 produced by the above procedures were evaluated at a measurement temperature of 25° C. First, the evaluation cells were charged with a constant current at 0.25 C (0.124 mA) to 1 V. The evaluation cells were rested for 30 minutes and were then discharged with a constant current at 0.25 C (0.124 mA) to 3 V. The discharge capacity at this time was 0.25 C. Thereafter, the evaluation cells were charged with a constant current at 10 C (4.97 mA) to 1 V and were discharged with a constant current at 0.25 C to 3 V. The discharge capacity at this time was 10 C. The result and the capacity retention, namely 10 C charge capacity/0.25 C charge capacity, are shown in Table 1.

TABLE 1

| | 0.25 C Charge | 10 C Charge | Charge |
|---|---|---|---|
| | Capacity | Capacity | Retention |
| | (mAh/g) | (mAh/g) | (%) |
| Example 1 | 166.0 | 149.9 | 90.3 |
| Example 2 | 165.3 | 151.0 | 91.4 |
| Comparative | 166.1 | 143.4 | 86.3 |
| Example 1 | | | |

As can be seen from Table 1, adding succinonitrile as a dinitrile compound to the non-aqueous electrolyte solution increases the capacity retention, namely, facilitates insertion of lithium, and the use of a titanium oxide for the negative electrode improves rapid charge and discharge properties. Moreover, the use of both LiPF₆ and LiBF₄ as lithium salts further improves the rapid charge and discharge properties.

### Experiment 2

### Example 3

### Production of Positive Electrode

A lithium manganese composite oxide with a spinel structure (LiMn₂O₄) as a positive electrode active material, a conductive material, and a solution of polyvinylidene fluoride (PVdF) in N-methylpyrrolidone (NMP) were mixed together, and NMP was added to the resultant mixture to prepare positive electrode composite slurry. One surface of a current collector made of aluminum foil and having a thickness of 20 μm was coated with the slurry so that the amount of active material was 9.3 mg/cm². After the coating, the resultant coated current collector was dried and pressed to a composite density of 2.9 g/cm³ to produce a positive electrode. The positive electrode was then dried under a reduced pressure at 130° C. for 8 hours.

<Production of Negative Electrode>

Acetylene black as a conductive material was added to powder of lithium titanate with a spinel structure (Li₄Ti₅O₁₂, lithium ion storage potential: 1.55 V versus Li/Li⁺, specific surface area: 4.2 m²/g, average particle size: 1.3 μm) as a negative electrode active material and mixed together. Then, a solution of polyvinylidene fluoride (PVdF) in N-methylpyrrolidone (NMP) was added to the mixture and mixed together. NMP was added to the mixed solution, and the resultant solution was then stirred and defoamed with the stirring/defoaming apparatus, THINKY MIXER, under the same operating conditions as those for the working electrode composite slurry in Experiment 1 to prepare negative electrode composite slurry. The mass ratio of Li₄Ti₅O₁₂:acetylene black:PVdF was 89.3:4.5:6.2. Thereafter, one surface of a current collector made of aluminum foil and having a thickness of 20 μm was coated with the prepared negative electrode composite slurry so that the amount of active material was 4.3 mg/cm². The resultant coated current collector was dried and then pressed to a composite density of 1.8 to 2.0 g/cm³ to produce a negative electrode. The negative electrode was then dried under a reduced pressure at 130° C. for 8 hours. The average particle size of the active material was measured by laser diffractometry (laser diffraction/scattering type particle size distribution measuring apparatus LA-950 made by HORIBA, Ltd.).

<Production of Electrode Group>

The positive electrode produced as described above, a separator made of rayon and having a thickness of 50 μm, the negative electrode produced as described above, and another separator were sequentially stacked on each other in this order so that the coated surfaces of the positive and negative electrodes faced each other with the separator therebetween. Then, the stack was wound into a flat shape so that the positive electrode faced outward, and the stack in the flat shape was fixed with an insulating tape. After the stack was fixed, a lead tab made of aluminum foil and having a thickness of 20 μm was welded to the current collectors of the positive and negative electrodes to produce an electrode group.

<First Step>

As a first step, the electrode group produced as described above was placed in a packaging member made of a laminated film so that the positive and negative electrode terminals were extended to the outside from one side of the packaging member. The resultant packaging member was vacuum dried at 100° C. for 12 hours. Thereafter, the non-aqueous electrolyte solution A of Example 1 was introduced into the packaging member to impregnate the electrode group with the non-aqueous electrolyte solution A. An opening of the laminated film was then temporarily sealed by heat sealing to produce a temporarily sealed secondary battery.

Actual capacity P of the positive electrode and actual capacity N of the negative electrode used in this temporarily sealed secondary battery were measured by the method described above. P was 0.78 mAh/cm² and N was 0.69 mAh/cm². In this temporarily sealed secondary battery, the ratio R of the negative electrode capacity to the positive electrode capacity, R=N/P, is 0.9, and designed capacity is 40 mAh.

<Second Step>

As a second step, the temporarily sealed secondary battery was sandwiched between two holding plates and fixed with a clip. The temporarily sealed secondary battery was thus pressed and left in this state for 3 hours. Thereafter, a current was applied between the positive and negative electrode terminals at 0.25 C (10 mA) to initially charge the temporarily sealed secondary battery at 25° C. until the negative electrode potential reached 1.2 V (versus Li/Li⁺; the same applies to the negative electrode potentials mentioned below). A cell charge cut-off voltage at this time was 3.0 V.

<Third Step>

As a third step, a part of the laminated film of the initially charged temporarily sealed secondary battery was cut off to open the temporarily sealed secondary battery, and the resultant secondary battery was placed in a reduced pressure chamber to discharge gas. Thereafter, the cut part of the laminated film was sealed again (finally sealed) by heat sealing. A non-aqueous secondary battery having discharge capacity of 40 mAh was produced in this manner.

### Example 4

A non-aqueous electrolyte secondary battery was produced by a method similar to that of Example 3 except that the non-aqueous electrolyte solution B of Example 2 was used as a non-aqueous electrolyte solution.

### Comparative Example 2

A non-aqueous electrolyte secondary battery was produced by a method similar to that of Example 3 except that the non-aqueous electrolyte solution C of Comparative Example 1 was used as a non-aqueous electrolyte solution.

<Measurement>

The following measurement was carried out for the non-aqueous electrolyte secondary batteries of Examples 3, 4 and Comparative Example 2 produced as described above.

<Measurement of Discharge Capacity>

The non-aqueous electrolyte secondary battery was stored in an incubator of 25° C. to stabilize the temperature of the battery. Then, the non-aqueous electrolyte secondary battery was discharged to SOC of 0% (1 C, cut-off voltage: 1.4 V). The non-aqueous electrolyte secondary battery was rested for 30 minutes and was then charged with a constant current at 1 C to 3.0 V. The non-aqueous electrolyte secondary battery was rested for 30 minutes and was then discharged at 1 C to 1.4 V. The capacity at this time is defined as the discharge capacity. The discharge capacity was measured under these conditions. The discharge capacity thus measured is defined as the initial capacity. The result is shown in Table 2.

<High Temperature Cycle Test>

The non-aqueous electrolyte secondary battery was placed in the incubator of 55° C. and was charged and discharged 50 cycles under the same charge and discharge conditions as those for the measurement of the capacity (charge: 1 C, cut-off voltage of 3.0 V, rest: 30 minutes, discharge: 1 C, cut-off voltage of 1.4 V, and rest: 30 minutes). The discharge capacity after the 50 cycles (capacity after the cycles) and the discharge capacity retention after the 50 cycles (=capacity after the cycles/initial capacity) are also shown in Table 2.

<Measurement of Amount of Gas>

The non-aqueous electrolyte secondary battery was placed in a graduated cylinder containing 100 ml of water to measure the volume of the battery. The volume of the battery was measured after the measurement of the initial capacity and after the 50 cycles of the high temperature cycle test. The amount of change in volume is defined as the amount of gas generated. The result is also shown in Table 2.

TABLE 2

| | Initial | Capacity | Discharge | Amount of Gas |
|---|---|---|---|---|
| | Capacity | after Cycles | Capacity | Generated |
| | (mAh) | (mAh) | Retention (%) | (ml) |
| Example 3 | 38.7 | 38.0 | 98.1 | 0.5 |
| Example 4 | 40.5 | 39.0 | 96.2 | 0.6 |
| Comparative | 39.7 | 35.6 | 89.7 | 1.2 |
| Example 2 | | | | |

As can be seen from Table 2, in Examples 3, 4 in which the non-aqueous electrolyte solution contains succinonitrile as an additive, the amount of gas after the high temperature cycle test is half that of Comparative Example 2 in which the non-aqueous electrolyte solution does not contain succinonitrile as an additive. Moreover, Examples 3, 4 have significantly improved discharge capacity retention over that of Comparative Example 2. Example 4 in which the non-aqueous electrolyte solution contains both LiPF₆ and LiBF₄ as lithium salts has larger initial capacity, but has slightly lower discharge capacity retention after the high temperature cycling.

### Experiment 3

### Example 5

A non-aqueous electrolyte secondary battery was produced by a method similar to that of Example 3 except that after the initial charge in the second step in Example 3, the initially charged temporarily sealed secondary battery was stored in an open circuit state for 48 hours in an incubator of 55° C., and as the third step, the temporarily sealed secondary battery stored was cooled to an ambient temperature and then the operation of the third step in Example 3 was performed.

### Example 6

A non-aqueous electrolyte secondary battery was produced by a method similar to that of Example 5 except that the non-aqueous electrolyte solution B of Example 2 was used as a non-aqueous electrolyte solution.

<Measurement>

Measurement was carried out for the non-aqueous electrolyte secondary batteries of Examples 5, 6 produced as described above. This measurement was carried out in a manner similar to that of Experiment 2. The result is shown in Table 3.

TABLE 3

| | Initial | Capacity | Discharge | Amount of Gas |
|---|---|---|---|---|
| | Capacity | after Cycles | Capacity | Generated |
| | (mAh) | (mAh) | Retention (%) | (ml) |
| Example 5 | 37.5 | 35.9 | 95.9 | 0.2 |
| Example 6 | 39.4 | 39.1 | 99.3 | 0.3 |

As can be seen from comparison between Tables 2 and 3, in Examples 5, 6 in which the high temperature storage process was added after the initial charge of the second step, generation of gas associated with a high temperature cycling is reduced as compared to Examples 3, 4. Comparison between Examples 4 and 6 in which the non-aqueous electrolyte solution contains both LiPF₆ and LiBF₄ as lithium salts shows that performing the high temperature storage process improves the capacity retention and the capacity is hardly deteriorated in the 50 cycles.

The factor that Example 6 has improved cycle properties over those of Example 4 is that high temperature storage allows succinonitrile to be sufficiently decomposed to form a satisfactory SEI coating film on the surface of the positive electrode. The factor that Example 5 has slightly smaller capacity than that of Example 3 is LiBF₄ as the lithium salt. When the battery is stored at a high temperature, LiBF₄ allows a thicker SEI coating film to be formed as compared to LiPF₆, and the capacity is reduced by an increase in resistance. Accordingly, in the case where the non-aqueous electrolyte solution contains both LiPF₆ and LiBF₄ as lithium salts, it is preferable that the molar concentration of LiPF₆ be higher than that of LiBF₄, and it is more preferable that the molar concentration of LiBF₄ be 0.001 to 0.2 mol/1.

### Experiment 4

### Example 7

### Production of Positive Electrode

Powder of lithium iron phosphate (LiFePO₄) as a positive electrode active material, acetylene black, and a solution of polyvinylidene fluoride (PVdF) in N-methylpyrrolidone (NMP) were mixed so that the mass ratio of LiFePO₄:acetylene black:PVdF was 83:10:7, and NMP was added to the mixture to prepare positive electrode composite slurry. Both surfaces of a current collector made of aluminum foil and having a thickness of 20 μm was coated with the positive electrode composite slurry so that the amount of active material on each surface was 9.5 mg/cm². After the coating, the resultant coated current collector was dried and pressed to a composite density of 1.9 g/cm³ to produce a positive electrode. The positive electrode was then dried under a reduced pressure at 130° C. for 8 hours.

<Production of Negative Electrode>

Powder of lithium titanium oxide used in Example 3 as a negative electrode active material, acetylene black as a conductive material, and a solution of polyvinylidene fluoride (PVdF) in N-methylpyrrolidone (NMP) were mixed so that the mass ratio of lithium titanate:acetylene black PVdF was 89.3:4.5:6.2, and NMP was added to the mixture to prepare slurry. Both surfaces of a current collector made of aluminum foil and having a thickness of 20 μm was coated with the slurry so that the amount of active material on each surface was 8.0 mg/cm². After the coating, the resultant coated current collector was dried and pressed to a composite density of 1.8 to 2.0 g/cm³ to produce a negative electrode. The negative electrode was then dried under a reduced pressure at 130° C. for 8 hours.

<Production of Electrode Group>

The sheet-like positive electrode produced as described above, a separator made of rayon and having a thickness of 50 μm, the sheet-like negative electrode produced as described above, and another separator were sequentially stacked on each other in this order, and the stack was fixed with an insulating tape. After the stack was fixed, a lead tab made of aluminum foil and having a thickness of 20 μm was welded to the current collectors of the positive and negative electrodes. An electrode group thus produced was a flat electrode group having a width of 36 mm and a thickness of 3.9 mm.

<First Step>

As a first step, the electrode group produced as described above was placed in a packaging member made of a laminated film so that the positive and negative electrode terminals were extended to the outside from one side of the packaging member. The resultant packaging member was vacuum dried at 80° C. for 8 hours. The non-aqueous electrolyte solution B of Example 2 was introduced into the packaging member to impregnate the electrode group with the non-aqueous electrolyte solution B. Thereafter, an opening of the laminated film was temporarily sealed by heat sealing to produce a temporarily sealed secondary battery.

Actual capacity P of the positive electrode and actual capacity N of the negative electrode used in this temporarily sealed secondary battery were measured by the method described above. P was 1.42 mAh/cm² and N was 1.28 mAh/cm². In this temporarily sealed secondary battery, the ratio R of the negative electrode capacity to the positive electrode capacity, R=N/P, is 0.9, and designed capacity is 440 mAh.

<Second Step>

As a second step, the temporarily sealed secondary battery was sandwiched between two holding plates and fixed with a clip. The temporarily sealed secondary battery was thus pressed and left in this state for 3 hours. Thereafter, a current was applied between the positive and negative electrode terminals at 0.25 C (110 mA) to charge the temporarily sealed secondary battery at normal temperature (25° C.) until the negative electrode potential reached 1.0 V. A cell charge cut-off voltage at this time was 2.5 V.

Subsequently, the initially charged temporarily sealed secondary battery was stored in an open circuit state for 168 hours in a 55° C. atmosphere (incubator).

As a third step, the temporarily sealed secondary battery stored was cooled to an ambient temperature, a part of the laminated film was cut off, and the resultant secondary battery was placed in a reduced pressure chamber to discharge gas. Thereafter, the cut part of the laminated film was sealed again (finally sealed) by heat sealing. The temporarily sealed secondary battery was assembled and conditioned in this manner to produce a non-aqueous electrolyte secondary battery having a width of 60 mm, a thickness of 3.9 mm, and a height of 83 mm.

### Comparative Example 3

A non-aqueous electrolyte secondary battery was produced by a method similar to that of Example 7 except that the non-aqueous electrolyte solution C of Comparative Example 1 was used as a non-aqueous electrolyte solution.

<Measurement>

Measurement was carried out for the non-aqueous electrolyte secondary batteries of Example 7 and Comparative Example 3 produced as described above. The measurement was carried out in a manner similar to that of Experiment 2 except that the charge and discharge cut-off voltages used in the measurement of initial discharge capacity and the high temperature cycle test were 2.5 V and 1.0 V, the high temperature cycle test was performed 500 cycles, and a graduated cylinder containing 500 ml of water was used for the measurement of the amount of gas. The result is shown in Table 4.

TABLE 4

| | Initial | Capacity | Discharge | Amount of Gas |
|---|---|---|---|---|
| | Capacity | after Cycles | Capacity | Generated |
| | (mAh) | (mAh) | Retention (%) | (ml) |
| Example 7 | 443.1 | 432.6 | 97.6 | 0.3 |
| Comparative | 446.3 | 424.5 | 95.1 | 0.6 |
| Example 8 | | | | |

As can be seen from Table 4, even when lithium iron phosphate is used as a positive electrode active material, the amount of gas after the 500 cycles of the high temperature cycle test in Example 7 in which the non-aqueous electrolyte solution contains succinonitrile as an additive is half that of Comparative Example 3 in which the non-aqueous electrolyte solution does not contain succinonitrile as an additive. Moreover, the discharge capacity retention in Example 7 is higher than that in Comparative Example 3.

### Experiment 5

### Example 8

### Production of Negative Electrode

Powder of lithium titanate with a spinel structure as a negative electrode active material, which is the same as that used for the working electrode in Experiment 1, acetylene black, and a solution of polyvinylidene fluoride (PVdF) in N-methylpyrrolidone (NMP) were mixed so that the mass ratio of Li₄Ti₅O₁₂:acetylene black:PVdF was 87.0:4.3:8.7, and NMP was added to the mixture to prepare negative electrode composite slurry. Both surfaces of a current collector made of aluminum foil and having a thickness of 20 μm was coated with the slurry so that the amount of active material on each surface was 8.0 mg/cm². After the coating, the resultant coated current collector was dried and pressed to a composite density of 1.8 to 2.0 g/cm³ to produce a negative electrode. The negative electrode was then dried under a reduced pressure at 130° C. for 8 hours.

<Production of Electrode Group>

A sheet-like positive electrode similar to that of Example 7, a separator made of rayon and having a thickness of 50 μm, the sheet-like negative electrode produced as described above, and another separator were sequentially stacked on each other in this order, and the stack was fixed with an insulating tape. After the stack was fixed, a lead tab made of aluminum foil and having a thickness of 20 μm was welded to the current collectors of the positive and negative electrodes. An electrode group thus produced was a flat electrode group having a width of 36 mm and a thickness of 3.9 mm.

<First Step>

As a first step, the electrode group produced as described above was placed in a packaging member made of a laminated film so that the positive and negative electrode terminals were extended to the outside from one side of the packaging member. The resultant packaging member was vacuum dried at 80° C. for 8 hours. The non-aqueous electrolyte solution A of Example 1 was then introduced into the packaging member to impregnate the electrode group with the non-aqueous electrolyte solution A. An opening of the laminated film was then temporarily sealed by heat sealing to produce a temporarily sealed secondary battery.

Actual capacity P of the positive electrode and actual capacity N of the negative electrode used in this temporarily sealed secondary battery were measured by the method described above. P was 1.42 mAh/cm² and N was 1.33 mAh/cm². In this temporarily sealed secondary battery, the ratio R of the negative electrode capacity to the positive electrode capacity, R=N/P, is 0.94, and designed capacity is 460 mAh.

<Second Step>

As a second step, the temporarily sealed secondary battery was sandwiched between two holding plates and fixed with a clip. The temporarily sealed secondary battery was thus pressed and left in this state for 3 hours. Thereafter, a current was applied between the positive and negative electrode terminals to charge the temporarily sealed secondary battery at 0.25 C (115 mA) at normal temperature (25° C.) until the negative electrode potential reached 1.0 V. A cell voltage at this time was 2.5 V.

Subsequently, the initially charged temporarily sealed secondary battery was stored in an open circuit state for 168 hours in a 55° C. atmosphere (incubator).

As a third step, the temporarily sealed secondary battery stored was cooled to an ambient temperature, a part of the laminated film was cut off, and the resultant secondary battery was placed in a reduced pressure chamber to discharge gas. Thereafter, the cut part of the laminated film was sealed again (finally sealed) by heat sealing. The temporarily sealed secondary battery was assembled and conditioned in this manner to produce a non-aqueous electrolyte secondary battery having a width of 60 mm, a thickness of 3.9 mm, and a height of 83 mm.

### Example 9

A non-aqueous electrolyte secondary battery was produced by a method similar to that of Example 8 except that the non-aqueous electrolyte solution B of Example 2 was used as a non-aqueous electrolyte solution.

### Comparative Example 4

A non-aqueous electrolyte secondary battery was produced by a method similar to that of Example 8 except that the non-aqueous electrolyte solution C of Comparative Example 1 was used as a non-aqueous electrolyte solution.

<Measurement>

Measurement was carried out for the non-aqueous electrolyte secondary batteries of Examples 8, 9 and Comparative Example 4 produced as described above. The measurement was carried out in a manner similar to that of Experiment 4 except that various charge and discharge current values were changed with 1 C=460 mAh. The result is shown in Table 5.

TABLE 5

| | Initial | Capacity | Discharge | Amount of Gas |
|---|---|---|---|---|
| | Capacity | after Cycles | Capacity | Generated |
| | (mAh) | (mAh) | Retention (%) | (ml) |
| Example 8 | 464.6 | 448.1 | 96.4 | 0.3 |
| Example 9 | 465.2 | 460.8 | 99.1 | 0.4 |
| Comparative | 465.9 | — | — | >3 |
| Example 4 | | | | |

Table 5 shows that the use of the non-aqueous electrolyte solution containing a dinitrile compound significantly reduces the amount of gas even if lithium titanate as a negative electrode active material has a large surface area. Comparison between Examples 8 and 9 shows that the non-aqueous electrolyte solution containing both LiPF₆ and LiBF₄ as lithium salts improves capacity retention. Comparison between Comparative Example 4 in Table 5 and Comparative Example 3 in Table 4 shows that, in the case of using the non-aqueous electrolyte solution containing no dinitrile compound, the amount of gas associated with a high temperature cycling is significantly increased if lithium titanate as a negative electrode active material has a large specific surface area. Since significant swelling of the battery was observed in Comparative Example 4, the capacity after the cycles was not measured in Comparative Example 4.

Although some embodiments of the present invention are described above, these embodiments are shown by way of example only and are not intended to limit the scope of the invention. These novel embodiments can be carried out in various other forms, and various eliminations, substitutions, and modifications can be made without departing from the spirit and scope of the invention. These embodiments and modifications thereof are included in the spirit and scope of the invention, and included in the invention described in claims and in the scope equivalent thereto.

### INDUSTRIAL APPLICABILITY

A non-aqueous electrolyte secondary battery that reduces generation of gas associated with a high temperature cycling and reduces capacity deterioration of the battery and that has excellent rapid charge and discharge properties is provided according to the present invention. The non-aqueous electrolyte secondary battery of the present invention can therefore be used for various known applications. Specific examples of the applications include a notebook computer, a pen input computer, a mobile computer, an electronic book player, a mobile phone, a mobile fax machine, a mobile copier, a mobile printer, a headphone stereo player, a camcorder, a liquid crystal display television, a portable cleaner, a portable CD player, a MiniDisc player, a handheld transceiver, an electronic organizer, a calculator, a memory card, a portable cassette tape recorder, a radio, a backup power supply, a motor, a car, a motorbike, a moped, a bicycle, a lighting apparatus, a toy, a game system, a clock, a power tool, an electronic flash, a camera, a power source for load leveling, and a power source for natural energy storage.

### REFERENCE SIGNS LIST

1 Non-Aqueous Electrolyte Secondary Battery
2 Positive Electrode
2a Positive Electrode Current Collector
2b Positive Electrode Active Material Layer
3 Negative Electrode
3a Negative Electrode Current Collector
3b Negative Electrode Active Material Layer
4 Separator
5 Non-Aqueous Electrolyte Solution
6 Packaging Member
7 Positive Electrode Terminal
8 Negative Electrode Terminal

1. A non-aqueous electrolyte secondary battery, comprising:
a positive electrode;
a negative electrode that includes an active material containing a titanium oxide having a lithium ion storage potential of 1.2 V or higher (versus Li/Li⁺); and
a non-aqueous electrolyte solution that contains a lithium salt, a non-aqueous solvent, and a dinitrile compound and/or a reaction product of said dinitrile compound.

2. The non-aqueous electrolyte secondary battery according to claim 1, wherein
a total amount of said dinitrile compound and/or said reaction product of said dinitrile compound in said non-aqueous electrolyte solution is 1 to 5 mass %.

3. The non-aqueous electrolyte secondary battery according to claim 1, wherein
charge capacity of said non-aqueous electrolyte secondary battery is regulated by said negative electrode.

4. The non-aqueous electrolyte secondary battery according to claim 1, wherein
said lithium salt includes at least lithium hexafluorophosphate and lithium tetrafluoroborate.

5. The non-aqueous electrolyte secondary battery according to claim 4, wherein
concentration of said lithium tetrafluoroborate in said non-aqueous electrolyte solution is 0.001 to 0.5 mol/1.

6. The non-aqueous electrolyte secondary battery according to claim 1, wherein
said non-aqueous electrolyte solution contains said dinitrile compound before initial charge.

7. The non-aqueous electrolyte secondary battery according to claim 1, wherein
said dinitrile compound is at least one selected from malononitrile, succinonitrile, glutaronitrile, and adiponitrile.

8. The non-aqueous electrolyte secondary battery according to claim 1, wherein
said titanium oxide is selected from lithium titanate with a spinel structure, lithium titanate with a ramsdellite structure, a monoclinic titanic acid compound, a monoclinic titanium oxide, and lithium hydrogen titanate.

9. The non-aqueous electrolyte secondary battery according to claim 1, wherein
said titanium oxide is selected from Li₄₊ₓTi₅O₁₂, Li₂₊ₓTi₃O₇, a titanic acid compound given by a general formula H₂TiₙO₂ₙ₊₁, and a bronze titanium oxide (where x is a real number that satisfies 0≦x≦3 and n is an even number of 4 or more).

10. The non-aqueous electrolyte secondary battery according to claim 1, wherein
said titanium oxide has a specific surface area of 5 m²/g or more as measured by a single-point BET method using nitrogen adsorption.

11. The non-aqueous electrolyte secondary battery according to claim 1, wherein
said non-aqueous electrolyte solution contains ethylene carbonate as a solvent and/or at least one selected from vinylene carbonate, ethylene sulfite, and 1,3-propanesultone as an additive.

12. The non-aqueous electrolyte secondary battery according to claim 1, wherein
an active material of said positive electrode is lithium iron phosphate.

13. The non-aqueous electrolyte secondary battery according to claim 1, wherein
an active material of said positive electrode is a lithium manganese composite oxide with a spinel structure.

14. A method for manufacturing a non-aqueous electrolyte secondary battery, comprising the steps of:
placing in a packaging member a positive electrode, a negative electrode that includes an active material containing a titanium oxide having a lithium ion storage potential of 1.2 V or higher (versus Li/Li⁺), and a non-aqueous electrolyte solution that contains at least a lithium salt, a non-aqueous solvent, and a dinitrile compound, and sealing an opening of said packaging member to produce a sealed secondary battery; and
charging said sealed secondary battery.

15. A method for manufacturing a non-aqueous electrolyte secondary battery, comprising the steps of:
placing in a packaging member a positive electrode, a negative electrode that includes an active material containing a titanium oxide having a lithium ion storage potential of 1.2 V or higher (versus Li/Li⁺), and a non-aqueous electrolyte solution that contains at least a lithium salt, a non-aqueous solvent, and a dinitrile compound, and temporarily sealing an opening of said packaging member to produce a temporarily sealed secondary battery;
adjusting a negative electrode potential of said temporarily sealed secondary battery to a potential higher than 0.8 V and equal to or lower than 1.4 V (versus Li/Li⁺) and storing said temporarily sealed secondary battery in an atmosphere of 50° C. or higher and lower than 80° C.; and
opening said temporarily sealed secondary battery to discharge gas therefrom, and then finally sealing said packaging member.

16. The method according to claim 15, wherein
said storage of said temporarily sealed secondary battery is performed in an open circuit.

17. The method according to claim 14, wherein
said non-aqueous electrolyte solution is introduced before said step of charging said sealed secondary battery.
